(19) United States
(12) Patent Application Publication
(10) Pub. No.: US 2004/0165615 A1
(43) Pub. Date: Aug. 26, 2004

(54) Response method for transmitting packet of the wireless network

(76) Inventor: Cheng-Chiang Huang, Shinjuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/373,058

(22) Filed: Feb. 26, 2003

(51) Int. Cl. H04J 3/16

(52) U.S. Cl. 370/465

(57) ABSTRACT

A response method for transmitting the packets in wireless network that can be used in wireless network when transmits packet, comprising the steps of: provide a first wireless network bridge to receive at least a packet from a cable LAN; the wireless network bridge set the address of MAC of the firmware by a program instruction; and process in transmitting the packet to a second wireless network bridge, then second wireless network bridge is to response a acknowledged message to the first wireless network bridge, and the acknowledged message of the response to correctly acknowledged to the workstation of the source and always change the role of the wireless network Access point client, i.e. Modify the MAC address of the firmware and acknowledge correctly and provide necessary packet.

### FIELD OF THE INVENTION

This invention relates to wireless communication systems, in particular, to a response method applied in transmitting packet that can be used in wireless network, provide a method without modifying the setting of firmware, and correctly acknowledge message to the workstation of the source.

### DESCRIPTION OF THE RELATED ART

The IEEE 802.11 communications standard has been used by some vendors to provide interoperability between wireless LAN equipment. The 802.11 standard specifies a protocol in which information is transmitted in packets. The standard specifies features such as packet size, packet content information, data rates, roaming, etc. The primary type of information was initially transmitted in systems that were designed to the 802.11 standard.

In some known systems, packets are simply transmitted in the order in which they have been received for transmission. In these known systems, a packet that is transmitted without being properly acknowledged by its intended recipient is repeated for a predetermined number of times while transmission of other remaining packets is delayed. After retransmitting a packet for a predetermined number of times without receiving a proper acknowledgment, the transmitter may proceed to transmit the remaining packets.

The demand for providing mixed voice and data traffic in wireless LAN systems has been increasing over recent years. Currently, the 802.11 standard does not provide specifications for providing voice communications. Information for providing voice communications is generally much more time critical than other information such as bar code information, package tracking information, etc. Communications for providing voice communications may require a greater volume of information to be carried by the system than when the system is providing communications for information that has typically been carried by wireless LANS. Moreover, the quality of voice communications is dependent on the rate in which information is exchanged. In data communications such as in communications for package tracking, the rate in which information is exchanged is non-critical because the quality of such communications is typically not a factor in evaluating the effectiveness of such communications.

Some known wireless LANs carry voice signals as part of the communications traffic but these systems are deficient in effectively meeting such complex communications demands as discussed above. Moreover, there may be a need to meet such demands with existing systems without substantially increasing system complexity, structure, design, cost, etc.

Historically, based on the geographic extent area there are three kinds of computer networks, Such networks are referred to as local area networks ((which will hereinafter be referred to as LAN), metropolitan area networks (MAN), or wide area networks (WAN). WANs generally extend over distances greater than approximately 150 Km. MAN generally extend over distances of from approximately 5 Km to approximately 150 Km. LANs generally extend over distances less than approximately 5 Km, it is ordinary known LAN as IEEE 802.3 Ethernet, IEEE 802.4 Token-Bus, and IEEE 802.5 Token-Ring, etc.

It has become widespread in short-range wireless communication technology, comprises three kinds of technology: Home RF ( radio frequency (“RF”) ) wireless home network, IEEE 802.11b wireless LAN and Blue tooth wireless personal network, wherein another recently adopted short-range standard has evolved known as the Blue tooth standard. The Bluetooth standard is a low-cost short-range wireless connection that uses much of the same range of frequencies for its frequency-hopping spread spectrum transmissions as the IEEE 802.11 standard. Blue tooth technology is most widespread developed by the characteristic of small-sized low-cost and user friendly. Bluetooth could be integrated to link wireless network on equipments which the cellar phone, portable computer and computer periphery, therefore, in future Bluetooth could provide better way of communication network especially in wireless internet). In the short term, Home RF could not be popularized by the limitation of bandwidth and product cost. The products of IEEE 802.11b wireless LAN could be another option for office environment Infrastructure.

In 1997 a standard for wireless local area networks (WLAN) known as the IEEE 802.11 standard has been adopted and has gained acceptance among the industrial, scientific and medical communities. The IEEE 802.11 standard for WLAN is a standard for systems that operate in the 2,400-2,483.5 MHz industrial, scientific and medical (ISM) band. The ISM band is available worldwide and allows unlicensed operation of spread spectrum systems. The IEEE 802.11 RF transmissions use multiple signaling schemes (modulations) at different data rates to deliver a single data packet between wireless systems. The latest IEEE 802.11 wireless LANuses a band of frequencies near 2.4 GHz for direct sequence spread spectrum transmissions. In short, wireless network is a LAN similar to the cable network employed the transmission technology structure, and function of wireless electric-waveₒ In speed, wireless transmit rate is consistently improved from 2M bits/sec and risen to 11 Mbits,could be 45 Mbits in nearby, to support rich network multimedia transmissionₒ

Based on the connection way there are three kinds of wireless LAN, comprising of: Ad-Hoc Network, Infrastructure Network, and Roaming Network; wherein Ad-Hoc Network is a symmetric wireless area without base station, Infrastructure Network is a link between wireless base station and cable LAN, Roaming Network is a Multipoint link of wireless base station.

Thereabout, referring now to FIG. 1 is the connection means of Infrastructure Network, wireless network is interconnected by a wireless network bridge 10′(Access Point) with Ethernet 20′, in this structure the wireless network bridge 10′is the server control end of wireless network, in charge of controlling message packet and messaging between wireless network and cable Ethernetₒ

Now, firmware is only acknowledge to wireless packet of particular destination, and wireless network bridge client is the client of back-end, for example: workstation, compromise management packet of IEEE 802.11, i.e. transmitting data packet, and firmware is not recognized by client of back-end, i.e. packet only be upload, not acknowledge to source responseₒ

Therefore, the present seeks to close a gap between aforementioned disadvantages and provide a response method for transmitting the packets in wireless network.

### SUMMARY OF THE INVENTION

Accordingly, it is therefore an object of this invention to provide a response method applied in transmitting packet that can be used in wireless network, provide the means of modifying wireless network access point client, and correctly acknowledge message to the source.

The another object of the present invention is to provide a response method applied in transmitting packet that can be used in wireless network, provide a method without modifying the setting of firmware, and correctly acknowledge message to the workstation of the source.

The present employed the characteristic of original Access point and Infrastructure STA, moreover, addition to Access point client back-end client in order to compromise the management packet and Forward data packet of 802.11 standard, the LAN of the Access point client back-end communicated with Access point by Access point client. It could not be achieved by only changing driver and without changing firmware, then the acknowledged message of the response be correctly response to the workstation of the source and always change the role of the wireless network Access point client, i.e. modify the MAC address of the firmware and acknowledge correctly and provide necessary packet.

### BRIEF DESCRIPTION OF THE DRAWING

These objects and other objects and advantages of the present invention will become more apparent upon reading of the following detailed description and the accompanying drawings in which:

FIG. 1 is a diagram showing a connection way used in the related Infrastructure network

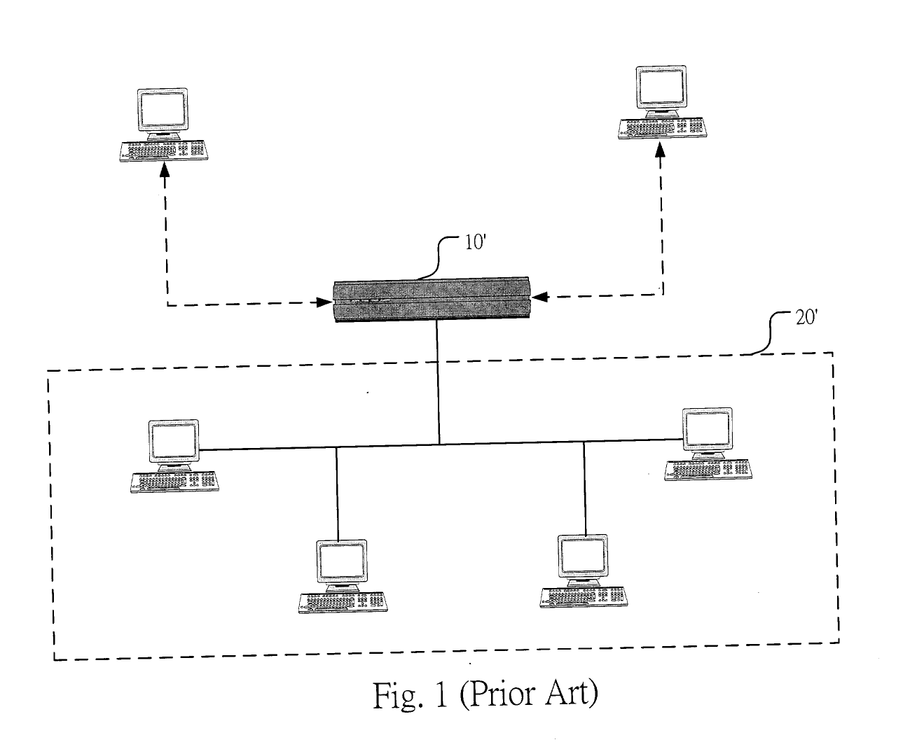

FIG. 2 is a flowchart showing a preferred embodiment of this invention; and

FIG. 3 is a diagram showing preferred embodiment.

### DESCRIPTION OF THE PREFERRED EMBODIMENTS

A response method according to an embodiment of the present Invention will now be explained with reference to the attached drawings.

At first, IEEE802.11 setup the specification of Medium Address Control (MAC) sub-layer of Physical Layer and Data Link Layer, is belonged to OSI (Open System Interconnection) which is 7 layers of communication structure.

The format of MAC frame is designed by IEEE 802.11includes frame Header and the length is 30 byte, comprises the fields of control information, addressing, sequencing number, duration, etc.

There are three kinds of MAC frame designed in the IEEE 802.11 standard respectively, control frames management frame and data frameₒ Before illuminated MAC frame, take a look at the formats of MAC frameₒ IEEE802.11 MAC frame is constituted by frame MAC Header, data Frame Body and FCS. In the frame header, there are the fields of Frame Control, Duration/ID, Address, and sequence controlₒ In data frame, disposed the data of client or management information, and the length is flexible, the maximum of length could not be more than 2312 byte, IN FCS.

There are three kinds of services provided in MAC of IEEE 802.11 ,comprising of: Asynchronous Data Services, Time Bounded Services and Security Services. Asynchronous Data Services, similar to the network transport, and mass packet have been transmitted in short time. Time Bounded Services is a necessary service because of multimedia popular, need to transmit information including voice and image in the limited time.

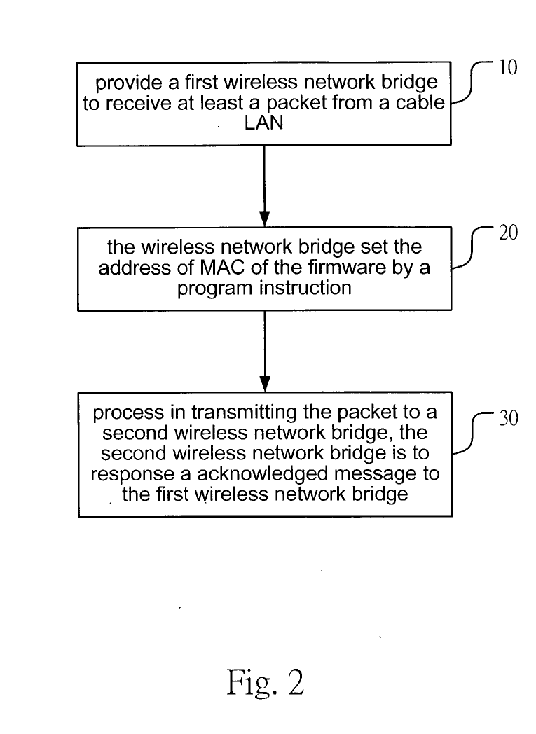

Further, the present is a response method for transmitting the packets in wireless network, referring now to FIG. 2, is a flowchart showing a preferred embodiment of this invention; comprises the steps of

step10, provide a first wireless network bridge to receive at least a packet from a cable LAN;

step 20,the wireless network bridge set the address of MAC of the firmware by a program instruction; and

Step 30,process in transmitting the packet to a second wireless network bridge, the second wireless network bridge is to response a acknowledged message to the first wireless network bridge.

Then the acknowledged message of the response be correctly response to the workstation of the source and always change the role of the wireless network Access point client, i.e. modify the MAC address of the firmware and acknowledge correctly and provide necessary packet.

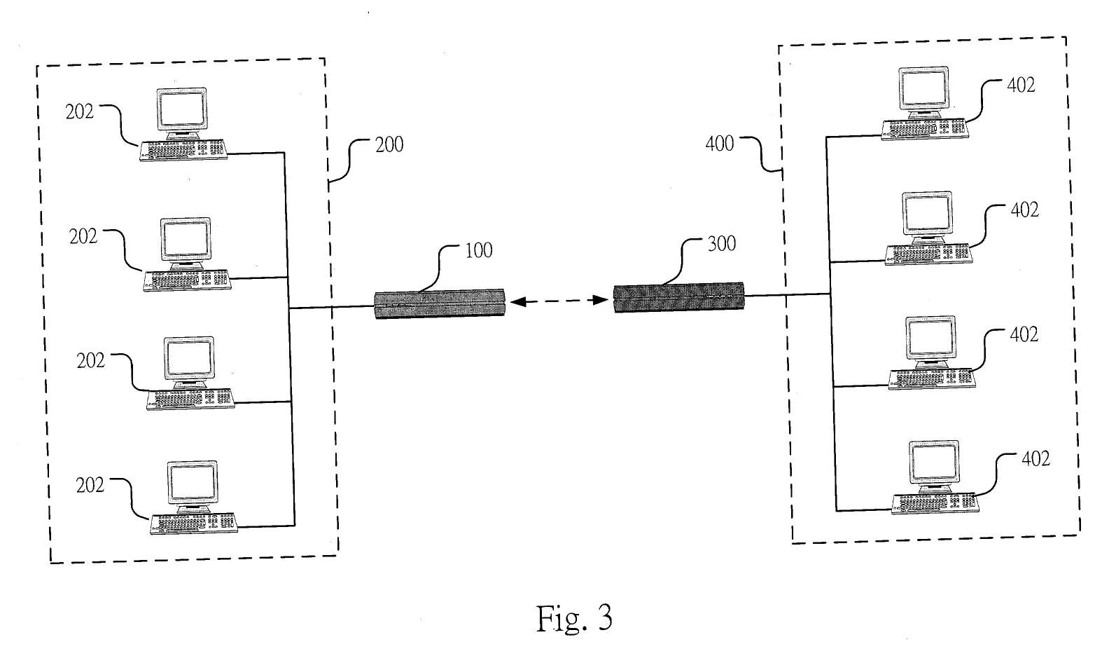

Referring now to FIG. 3 of the drawing, is a diagram showing preferred embodiment; as referred in Fig, a wireless network Access point client 100, a first cable LAN 200, workstation 202, a wireless network bridge 300, a second cable LAN 400 and workstation 402 there are included in the present.

In the workstation 202 of first cable LAN 200, transmitting a packet to the second cable LAN 400 of the wireless network bridge 300 by a wireless network Access point client 100,and when the wireless network Access point client 100 transmit to the wireless network bridge 300, the wireless network Access point client 100 could not distinguish packet transmitted to back-end whether from workstation 202 of the first cable LAN 200,and the wireless network Access point client 100 could not response to workstation, or when the wireless network Access point client 100 from first cable LAN 200 receive packet and when the wireless network bridge 300 from the second cable LAN 400 receive packet, it could not be able to transmit acknowledged message and the workstation of back-end.

Therefore, the present could only modify MAC Address of firmware instead of changing the setting of firmware by a program instruction, in other words, i.e., always tracking wireless network Access point client to acknowledge response message and packet.

Thus it is seen that a wireless LAN system and methods are provided that effectively carry mixed traffic communications. Greater priority is given to the transmission of packets for voice communications than for data communications while preventing transmission of data communications from being substantially blocked. Moreover, the system and methods, while meeting the complex demands of a mixed communications traffic environment, may still be implemented without substantial increases in structure, complexity, cost, processing delay, etc. over known wireless LAN systems and methods.

What has been described above are preferred embodiments of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims. Various embodiments and changes may be made thereunto without departing from the broad spirit and scope of the invention. The above-described embodiment is intended to illustrate the present invention, not to limit the scope of the present invention.

The scope of the present invention is shown by the attached claims rather than the embodiment. Various modifications made within the meaning of an equivalent of the claims of the invention and within the claims are to be regarded to be in the scope of the present invention.

What is claimed is:

1. A response method for transmitting the packets in wireless network, comprising the steps of:
providing a first wireless network bridge to receive at least a packet from a cable LAN
the wireless network bridge setting the address of MAC of the firmware by a program instruction; and
processing in transmitting the packet to a second wireless network bridge, the second wireless network bridge is to response a acknowledged message to the first wireless network bridge, then the acknowledged message of the response be correctly response to the workstation of the source.

2. The response method as claimed in claim 1, wherein the wireless network is wireless LAN transmission technology of the spread spectrum.

3. The response method as claimed in claim 1, wherein the wireless network is IEEE 802.11 wireless LAN standard.

4. The response method as claimed in claim 3, wherein the wireless LAN standard is an Infrastructure Network.

5. The response method as claimed in claim 3, wherein the MAC frame based on the IEEE 802.11 includes a control frame, a management frame and a data frame.

6. The response method as claimed in claim 5, wherein the format of the MAC frame includes a MAC Headers a Frame Body and a FCS.

7. The response method as claimed in claim 1, wherein the correctly response message method is achieved by changing the wireless network Access Point Client
